(19) United States
(12) Patent Application Publication
(10) Pub. No.: US 2012/0226558 A1
(43) Pub. Date: Sep. 6, 2012

(54) Dynamic Advertising System

(76) Inventor: Steven Robyor, St. George, VT (US)

(21) Appl. No.: 13/037,586

(22) Filed: Mar. 1, 2011

(51) Int. Cl. G06Q 30/00

(52) U.S. Cl. 705/14.66; 705/14.4; 705/14.73

(57) ABSTRACT

A real-time database system for creating and searching for advertisements, discounts and/or coupon offers. The system allows full dynamic control to merchants, which provides an ability to generate electronic advertisements, monitor competitor advertisements, and dynamically change existing advertisements in real-time, in response to changes in the marketplace, or in response to competitor activity. This will allow business owners to offer the best available price, and consumers to locate the best available price in one location.

### BACKGROUND

1. Technical Field

This invention relates in general to online advertising systems, and more particularly it relates to an online system in which an online server supporting multiple merchants allows each merchant to directly and dynamically control, in real-time, advertisements related to their business and also dynamically control the terms of discounts or coupons for goods and services they may offer.

2. Background of the Invention

Traditional advertising consists mainly of printed materials or graphically detailed, online advertising, which are static in nature. These advertisements can be a simple advertisement offering standard goods and services, or they can be advertisements offering special deals, such as discounts or coupons. The static nature of these prior advertisements means that once an advertisement is published there is no way to alter the specifics, especially in any type of print medium. Additionally, some companies develop purchasing power through online group activities, and this flawed method of offering discounts mainly benefits consumers. This negatively affects businesses seeking a beneficial and cost effective marketing strategy.

More recently, host companies have developed Internet Web sites to provide merchants with the ability to advertise their goods or services, and to offer discounts or coupons electronically. As the Internet has become more popular, merchants have found it to be an important source of new customers and repeat business. Recently, a number of Web sites have begun to provide electronic coupons or coupons for use at a variety of merchant outlets. These Web sites provide an online advertising service that is functionally equivalent to the services provided by conventional newspapers when they provide printed coupons. This process generally involves a merchant contacting an advertising medium (e.g. newspaper, magazine, etc.) or Web site and placing an advertisement for particular goods or services, or by offering online “click ads” to redirect consumers to an advertiser's Web site. Once the advertising medium or Web site accepts the offer, and publishes the merchant's information, which may include a discount or coupon advertisement, the advertisement enters the public sphere where it is available to anyone who uses the advertising medium, or the Web site. Unfortunately, the offers made through these prior art systems are not capable of real-time modification by the merchant.

While prior art of advertising systems have historically provided, and continue to provide, a substantial source of business traffic for merchants, the fixed form of discount or coupon that advertising mediums and Websites publish do not allow merchants to dynamically respond to the marketplace, and do not allow merchants to have dynamic direct control over the advertisement, discount, or coupon. As a result, merchants are at a disadvantage and may lose a substantial amount of business because competitors may undercut a merchant's price by just enough to gain a sale that would otherwise have gone to the merchant. Another disadvantage is that an unexpectedly large number of consumers who have purchased bulk discounts or coupons may inundate a merchant. This places the merchant in an unacceptable situation, which may even put the merchant out of business. Because prior art systems do not allow merchants to control advertisements, discounts, or coupon offers in real-time, the merchant is at a significant disadvantage from competitors. It would be desirable to have a system that allows a merchant to directly control advertisements dynamically without having to contact any third-party individual, advertising medium, Web site, or marketing company and go through a protracted process of updating advertisements, discounts, or coupons, or altering expensive print advertising.

Prior art systems fail to contain dynamic integration properties in which business owners have full control with which to alter advertisements, discounts, or coupon offers to consumers in real-time. It would be desirable to have a system that provides this full control to business owners.

While the prior art has provided basic advertisement services, it has failed to allow merchants to directly control, and modify in real-time, the advertisements, discounts, and coupons they provide in an online environment.

### SUMMARY OF THE INVENTION

This invention provides an online system in which consumers can access the system to search for particular goods and/or services. The system further provides an individual merchant with the ability to provide electronic advertisements, discounts, or coupons, to monitor competitor offers, and to change existing advertisements, discounts, or coupon offers dynamically in response to changes in the marketplace.

### BRIEF DESCRIPTION OF THE DRAWINGS

FIG. 1 is a block diagram of a preferred embodiment of the dynamic advertising system.

### DETAILED DESCRIPTION OF THE PREFERRED EMBODIMENT

Prior to a discussion of the figures, an overview of the invention will be presented. The invention is an online, dynamic advertising system that allows a merchant to directly and dynamically control the terms of advertisements, discounts, and/or coupons in real time. For ease of discussion, the terms “advertisement” or “advertising” shall mean a conventional advertisement describing the merchants goods or services, a discount offered by the merchant, and/or coupon offered by the merchant. The term “dynamic” defines an active real-time process, which allows full control of any advertisement, or discount offers made by the merchant once the advertisement goes public. This merchant control is obtained when the advertisement is placed on the dynamic advertising system server. Unlike past systems, the merchant has the ability to maintain and control every aspect of the advertisement through a secure administration page. Consumers will see advertisements in real-time on the server. In addition, the system uses time constraints and quantity limits for each advertisement that is controlled by the merchant. The merchant has full control of the quantity of consumers who obtain discounts offered via their advertising. When the merchant reaches the desired quantity of consumers, or the time limit expires, the offer ends automatically. The invention gives full dynamic control to merchants when deciding price, duration, and quantities available for an advertisement, discounts and/or coupon offerings.

The invention is an online discount system that allows consumers to search for online discount offers as is presently done in the prior art. However, the invention provides any type of business entity with dynamic control over their advertisements, discount offers, and/or coupons that heretofore has never existed. This allows consumers to find the best available price or discount by comparing merchant offers in real-time. In addition, merchants using this invention can modify advertisements or discount offers in real-time based on marketplace conditions, and/or conditions or requirements within the merchant's business. This will attract consumers while creating a collective market power of competitive pricing. The invention also allows merchants to correct any inconsistencies. For example, a merchant may publish a number of advertisements offering discounts for goods or services that were available at the time of publication. However, an unexpected surge in demand, or problems associated with obtaining inventory may create a situation where the merchant wants to discontinue or modify an advertisement or discount offer or desired consumer quantity. Likewise, a merchant may discover an error in a published discount offer and may wish to correct the error immediately.

In addition to the foregoing, a merchant may publish an advertisement and then find out a competitor is offering a better price. In this situation, if the merchant does not respond to the competitor's offer quickly enough, a significant number of sales may be lost. Unfortunately, prior art systems do not allow merchants to act quickly enough, and renders immediate action impossible. An advantage provided by the invention described herein is that it gives merchants full control over any advertisements, discounts, and/or coupon offers presented to consumers immediately and accurately using an online system. Therefore, when the need arises, merchants can modify discount offers dynamically, in real-time, allowing for complete control over any price or discount offer presented to the public 24/7/365.

Another advantage provided by the invention is that merchants can do a competitive market analysis by searching advertisements, or any discounts offered by competitors. Once the merchant is aware of what the competition is offering, the merchant can modify an offer and be better able to compete for consumers. As a result, instead of losing business to competitors, as would be the case using prior systems, dynamic merchant-controlled real-time modification gives merchants a competitive edge. This allows merchants to offer the best available price, and consumers to locate the best available price in one location.

In the prior art, it is not possible for merchants to immediately act in response to required changes in the published advertisement, discount, or coupon. The invention provides merchants with an important tool that allows them to dynamically modify advertisements, discounts, and/or coupons in response to the marketplace, and/or in response to the merchant's internal situation or requirements.

Having discussed the invention in general, we turn now to a detailed discussion of the drawings.

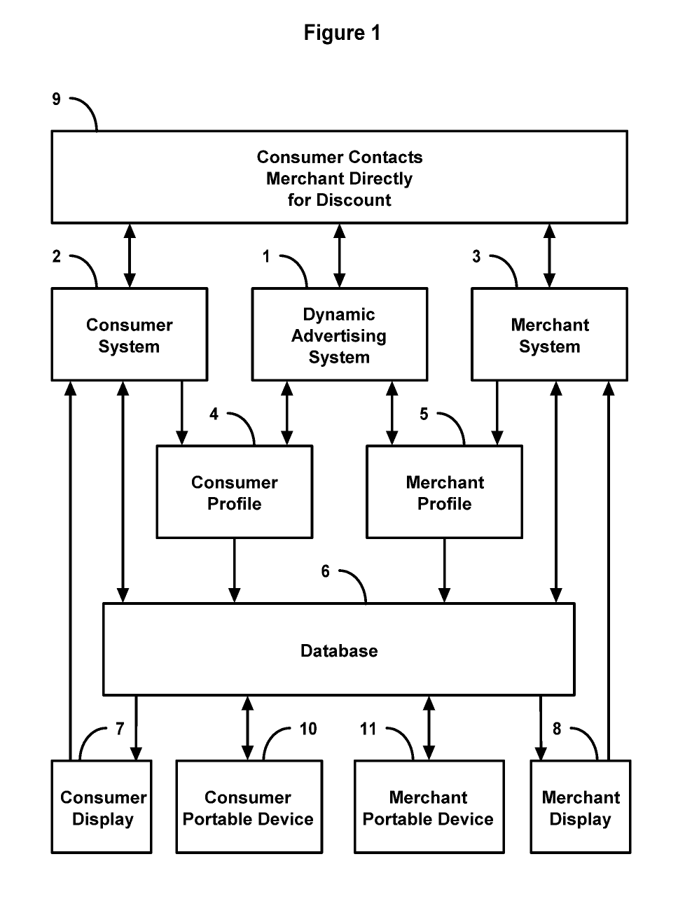

Regarding FIG. 1, the dynamic advertising system (“DAS”) 1 is shown. The DAS 1 is the Web server which hosts all the merchants who subscribe to the system, and by which provides access by all of the consumers who want to search for merchant discounts. The DAS 1 services any number of remote consumer systems 2 and any number of remote merchant systems 3. When a consumer uses the DAS 1, it fills out a consumer profile 4 which is accessed and controlled by the DAS 1. At this point, the DAS 1 has access to all of the information it needs to provide services to the customer system 2.

When a merchant engages the DAS 1 to provide services related to merchant advertising, or discounts, the merchant system 3 provides information about the merchant that is entered into the merchant profile 5. As was the case with the consumer system 2, the DAS 1 also has access to information placed in the merchant profile 5 by the merchant.

In the normal course of business, the merchant system 3 will enter information regarding the merchant's advertisements into the database 6. Information from the merchant profile is used to construct advertisements, thereby eliminating redundant efforts on the part of the merchant system 3 as advertisements are generated. Once the advertisements are generated and made available in the database 6, a consumer system 2 can search the database 6 for products and/or services desired by the consumer by product related keywords and entering geographical search criteria such as a zip code, or other locality identifying information. The consumer system 2 then displays information resulting from the search on the consumer's display 7. Once the consumer has located the desired goods or services they are seeking, the consumer will have multiple options presented. For example, an auto-generated code identifier (ACI) for a multitude of business owners who take reservations or require appointments, like restaurants, doctors, dentists, massage services, hair salons, etc. A redeemable linear or matrix barcode for goods offered by retailers for immediate exchange will be available. The consumer will have the option to print an offer on the consumer system 2, or alternatively, the consumer can directly contact the merchant via link 9. In the preferred embodiment, the DAS 1 also has access to consumer/merchant link 9.

The ability of the merchant to access the database 6 and dynamically make real-time changes to the merchant's advertisements and to respond to competitors dynamically in real-time provides the merchant with a valuable tool in attracting consumers, and also redirecting consumers to the merchant's Web site. This provides a very effective and useful merchant tool, which heretofore has never existed.

The following example illustrates how the invention might be used in a service business:

### Example

### A Dental Office

A dentist would like to attract more clients. The dentist creates an account with DAS 1 system. Within the Merchant Administration Page (MAP), the dentist creates an advertisement. In the advertisement, the dentist offers a discount off teeth whitening when someone schedules a full price cleaning. Therefore, every customer who schedules a full price cleaning with the advertisement's discount code will receive whatever discount the dentist decides; let us say the discount offer is twenty-five percent off teeth whitening with a full price teeth cleaning. Once the advertisement posts, the dentist can change the time duration, discount percentage, and amount of new customers the dentist would like to attract. In this example, the dentist would like to attract thirty new customers.

When a consumer, searching for teeth whitening sees the discount advertisement, the consumer must make an appointment within the allotted time set by the dentist. On the ad page, the consumer will click on a graphic titled: “Schedule an Appointment.” After clicking on the graphic, the consumer will receive an auto-generated code identifier (ACI) and the words “Pending Appointment” will appear. The consumer must contact the dentist's office (all relevant contact information is located within the advertisement) and follow the directions on how to give this ACI during the scheduling process for the appointment. When the dentist created the discount ad, the dentist received thirty ACIs. The dentist will then compare the consumer's ACI with the dentist's auto-generated set during the scheduling process. Once the consumer makes the appointment, the dentist will enter the MAP and mark the matching ACI with the “Pending Appointment” ACI as a “Confirmed Appointment.” This will reflect on the advertisement page showing the number of remaining appointments available to future consumers. Only the consumer clicking the “Schedule an Appointment” will see the “Appointment Pending” notification. When the consumer makes an appointment, and the dentist confirms the appointment, the consumer will see an “Appointment Confirmed” notification within the consumer's account page. In the event that other consumers are viewing this dentist's advertisement, consumers will see the statistics change in real-time. The consumer will only see pertinent information related to the dynamic advertising strategy applied by the dentist.

An example is:

| | |
|---|---|
| Total Discounts Offered: | 30 |
| Pending Appointments: | 3 |
| Confirmed Appointments: | 25 |
| Available Discounts Remaining: | 2 |

Once the “Available Discounts Remaining” reaches 0, the dentist will have received the desired amount of new customers. The advertisement will immediately expire (regardless of how many “Pending Appointments” remain), and removed automatically from the DAS 1 system. In the MAP, the dentist will see the pertinent information related to every advertisement offer; in this example, the expired notification the dentist reached the desired amount of new customers.

This is one example of how an advertisement may be displayed, and is not conclusive by example. The objective of this invention is to create an environment in which the merchant has full control over any type of advertising, regardless of the means put forward. This type of environment will allow enticement for the consumer, and allow a consumer to locate the best available price or discount on available goods and services offered by any business. In the example above, consumers will see a clock in real-time as in prior art; however, because of the real-time control of the business, at any time the dentist would like to add more customers, the dentist can simply start all over again. During the advertising offer, the dentist can also see what other dentists in the area are offering, and meet or beat the offers. This will create a competitive edge and collective market power between businesses.

Those skilled in the art will recognize that the DAS 1 can be implemented on any suitable hardware system and on any suitable software platform. The system can range in size from a personal computer, to a server, to a mainframe computer, and/or to a distributed network of computers. Likewise, any software capable of interacting with the Internet for the functions provided by this invention can be used. The DAS 1 is also independent of the particular hardware/software systems used by the consumer system 2 or the merchant system 3. The only requirement is that they be capable of communicating via the Internet.

For ease of discussion, the foregoing embodiment has been discussed in terms of conventional personal computers, servers, mainframes, etc. However, those skilled in the art will recognize that any intelligent device can be used in combination with the invention. For example, the consumer system 3 can be a personal computer, or larger business computer, but it can also be a portable consumer device 10. A portable consumer device 10 can be an intelligent device, such as a smart phone (e.g. an iPhone™, a Blackberry™, etc.), a tablet computer (e.g. an iPad™, etc.) or any other intelligent device that is capable of communicating with the Internet. Likewise, the merchant has the same freedom. In the preferred embodiment, the merchant can also access the database 6 via a merchant portable device 11. As was the case with the portable consumer device 10, a merchant consumer device 11 can also be any intelligent device, such as those described in regard to consumer portable devices 10, so long as it is capable of communicating with the Internet and does not have to be a traditional computer.

While specific embodiments have been discussed to illustrate the invention, it will be understood by those skilled in the art that variations in the embodiments can be made without departing from the spirit of the invention. Therefore, the invention shall be limited to the scope of the claims.

I claim:

1. A merchant controllable advertising system, comprising:
a dynamic advertising system;
a database containing information about goods and/or services associated with particular merchants, the database operatively connected to and under the control of the dynamic advertising system;
a plurality of consumer systems, the consumer systems having means to search the database under control of the dynamic advertising system; and
a plurality of merchant systems, the merchant systems having means to create, delete, and/or modify advertisements for entry into the database under control of the merchant system;
whereby the merchant system has direct, real-time, control over advertisements being offered through the dynamic advertising system.

2. A system, as in claim 1, further comprising:
a merchant profile database, the merchant profile database further comprising information entered by the merchant that pertains to the merchant.

3. A system, as in claim 1, further comprising:
a consumer profile database, the consumer profile database further comprising information entered by the consumer that pertains to the consumer.

4. A system, as in claim 1, wherein:
the consumer system further having means to select an advertisement for goods and/or services resulting from a search of the database.

5. A system, as in claim 4, further comprising:
a printer attached to the consumer system; and
means to print the selected advertisement on the consumer system.

6. A system, as in claim 4, further comprising:
means in the consumer system to directly contact the merchant system in response to an advertisement located in the search of the database.

7. A system, as in claim 4, wherein:
the consumer system is a portable device.

8. A system, as in claim 7, wherein:
the portable device is a smart phone.

9. A system, as in claim 7, further comprising:
the portable device is a tablet computer.

10. A system, as in claim 7, further comprising:
means in the consumer system to directly contact the merchant system in response to an advertisement, discount, or coupon offer located in the search of the database.

11. A system, as in claim 1, further comprising:
means in the merchant system to directly search the database for offers by other merchant systems.

12. A system, as in claim 11, further comprising:
means to dynamically create or modify advertisement under direct control of the merchant system.

13. A method of dynamically creating or modifying online merchant advertisements under direct control of the merchant, including the steps of:
using a dynamic advertising system, in an online environment, to control a database of advertisements from merchants;
storing information about advertisements associated with particular merchants in a database;
searching the database with at least one consumer system; and
dynamically creating, deleting, or modifying advertisements associated with a particular merchant under control of that particular merchant system;
whereby the merchant system has direct, real-time, control over advertisements being offered through the dynamic advertising system.

14. A method, as in claim 13, including the additional step of:
using a merchant profile database to store information entered by the merchant that pertains to that merchant.

15. A method, as in claim 14, including the additional step of:
using the merchant system to directly search the database for advertisements by other merchant systems.

16. A method, as in claim 15, including the additional step of:
dynamically creating, deleting, or modifying advertisements, under direct control of the merchant, in response to advertisements by other merchant systems.

17. A method, as in claim 16, including the additional step of:
using a smart phone or a tablet computer as the merchant computer.

18. A method, as in claim 14, including the additional step of:
using the consumer system to search the database.

19. A method, as in claim 18, including the additional step of:
using a portable device as the consumer system.

20. A method, as in claim 19, including the additional step of:
using a tablet computer or a smart phone as the portable device.
